(19) United States
(12) Patent Application Publication
(10) Pub. No.: US 2007/0130323 A1
(43) Pub. Date: Jun. 7, 2007

(54) Implied presence detection in a communication system

(76) Inventors: Richard A. Landsman, Scotts Valley, CA (US); Timothy T. Sullivan, Portolo Valley, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/292,645

(22) Filed: Dec. 2, 2005

(51) Int. Cl. G06F 15/173

(52) U.S. Cl. 709/224

(57) ABSTRACT

The present invention provides for systems and methods for determining the likelihood that an intended recipient is currently available to communicate via at least one communication mechanism. A presence module monitors the computer usage activity of the intended recipient. The data relating to the computer usage activity of the intended recipient is stored in a database, and is later utilized by a processing module for determining the likelihood that the intended recipient is currently available to communicate via the at least one communication mechanism. The likelihood that the intended recipient is currently available to communicate via the at least one communication mechanism is displayed to at least one other user by an interface module. A communication module is configured to send a message to the intended recipient via the at least one communication mechanism.

### BACKGROUND

1. The Field of the Invention

The present invention relates generally to the determination of whether a user is within close proximity to a computer, and more particularly, to methods and systems for determining a user's availability to participate in certain forms of data communication.

2. The Relevant Technology

Computer systems and related technology affect many aspects of society. Indeed, the computer system's ability to process information has transformed the way we live and work. Computer systems now commonly perform a host of tasks (e.g., word processing, scheduling, database management, etc.) that prior to the advent of computer systems were performed manually. More recently, computer systems have been coupled to one another to form computer networks over which the computer systems can communicate electronically to share data.

Often, electronic communication on a network includes a client computer system (hereafter referred to as a “client”) requesting access to a network service at a server computer system (hereinafter referred to as a “server,” or “host”). Accordingly, the client sends a request to the server for particular access to its system resources, wherein if the client is authorized and validated, the service responds with a response message providing the desired information. Of course, other messaging patterns between client and service are available and include simple singleton messages as well as more sophisticated multi-message exchanges like, e.g., notification, solicit-response, pub-sub patterns, polling, kick-push, queuing, and others. Further, these types of communication are governed by various requirements and capabilities defined by both the client and the service in contracts for distributed systems.

Along with computing systems, the Internet has revolutionized the way people communicate and has ushered in a new era in human history often termed the “information age.” In essence, the Internet includes a large constellation of networked computers that are spread out over much of the world. Sophisticated computers, software and networking technology have made communication over the Internet fairly straight forward from the view point of end user.

With the advent of the Internet, electronic messaging systems (e.g., email, messaging boards, instant messaging (IM), etc.) Have become an increasingly popular way to communicate. For example, businesses increasingly rely on electronic messages to share idea, transmit documents, schedule meetings, and perform a multitude of other every day tasks. Further, individuals utilize messaging systems to communicate and interact with family, friends, business associates, acquaintances, or any other desired individuals within ones interactive community.

Online service providers are constantly offering new services and upgrading existing services to enhance their subscribers' online experience. Subscribers have on-demand access to news, weather, financial, sports, and entertainment services as well as the ability to transmit electronic messages and to participate in online discussion groups. For example, subscribers of some online service providers may view and retrieve information on a wide variety of topics from servers located throughout the world. A server may be maintained by the service provider or by a third party provider who makes information and services available through the worldwide network of computers that make up the online service.

In recent years, certain forms of online communication have also grown in popularity because of the instantaneous nature in which the internet allows users to communicate. In particular, simultaneous internet communication, such as instant messaging and voice over internet protocol (VoIP), has grown in popularity. Simultaneous internet communication is an internet protocol (IP) based form of communications between two or more participants requiring that all participants be simultaneously connected to an IP-based network in some manner. Simultaneous internet communication allows two or more users to participate in a continuous conversation wherein the users are allowed to exchange messages in a simultaneous manner.

For example, one example of simultaneous internet communication is instant messaging. Instant messaging consists of private online conversations between two or more people who have subscribed to the instant messaging service and have installed the necessary software. Because instant messaging takes place in real time, instant messaging can provide immediate access to desired information. Instant messaging is becoming a preferred means of communicating among online subscribers.

Many instant messaging clients offer a “presence awareness” feature, indicating whether people on a user's list of contacts are currently online and available to participate in an instant messaging conversation. The list of a user's contacts may be referred to as a “Buddy List” or “Contact List.” The presence awareness feature may be referred to as a user's instant messaging “status.” Generally a user's status is manually configured by the user, or is defaulted to a specific setting when the user logs onto a computer or makes an online connection. Depending on the instant messaging client being used, a user's status may be set to Online, Away, Not-online, Idle, Invisible, Do Not Disturb, Urgent Messages Only, etc.

However, the presence awareness feature may not accurately describe the actual ability of an instant message recipient to promptly respond to an instant message sent by a sender. For example, a recipient might manually set her status to “online” to indicate to the recipient's contacts that she is currently available to participate in an online conversation. However, if the recipient steps away from her computer and neglects to update her status to “away”, the recipient could potentially receive an instant message from a sender who assumes, based on the recipient's online status, that the recipient is currently able to participate in an instant messaging conversation. Not until waiting several minutes for the recipient to respond will the sender finally realize that the recipient's status of “online” was probably incorrect.

Similarly, a recipient may manually set a status bar to “away” or “offline” to indicate that the recipient is not available to participate in an IM conversation. However, even with a status of “offline” or “away”, the recipient may still be willing to IM with certain individuals, or may forget to update the status bar to “online” once the recipient would be willing to participate in an IM conversation.

Other types of online simultaneous internet communication mediums exist. For example, voice over Internet Protocol (VoIP) is currently increasing in popularity. VOIP is the routing of voice conversations over the Internet or any other IP-based network. The voice data flows over a general-purpose packet-switched network, instead of traditional dedicated, circuit-switched voice transmission lines. Protocols used to carry voice signals over the IP network are commonly referred to as Voice over IP or VoIP protocols. Thus, VoIP suffers from similar drawbacks as instant messaging.

Further, various other communication means could also benefit from a more accurate indication of the availability of a recipient.

### SUMMARY OF THE INVENTION

These and other limitations are overcome by embodiments of the present invention, which relate to systems and methods for detecting implied presence in a communication system. Embodiments of the present invention include systems and methods for displaying the likelihood that a particular recipient is available to communicate using various forms of communication. The invention includes a presence module for monitoring the computer usage of a user for the purpose of determining the likelihood that the user is within close proximity to his or her computer. The presence module may monitor the local usage of the user's computer, the online usage by the user, or a combination of both.

The data collected by the presence module is stored in a database and used by a processor to determine the likelihood that the user is within close proximity to his or her computer. The data used to make this determination may include the recency of the user's computer usage, other status indicators that may either be manually set by the user or automatically set by the user's computer, the amount of the user's computer usage, user preferences, information regarding the user's contacts, among other data.

Once a determination is made as to the likelihood that the user is within close proximity to his or her computer, an interface module may display the calculated likelihood to another person. Based on this information, the person or a computer can make the determination of whether to attempt to contact the user by one or more communication mechanisms. The communication mechanism may include instant messaging, VoIP, email, teleconferencing, telephone and mobile phone, and a variety of other IP-based and non-IP-based communication means.

If the first attempt to contact the user via the first communication mechanism fails, then the system may suggest alternate communication mechanisms for contacting the user. For example, if the system's first attempt to contact the user by instant messaging fails, then the system may suggest that an attempt be made to contact the user via email or cell phone.

These and other features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of one embodiment of the invention for allowing a first user to obtain implied presence information regarding a second user.

FIGS. 2a and 2b illustrate Graphical User Interfaces that may be displayed to a user of the present invention.

FIG. 3 illustrates a block diagram of one embodiment of the invention for allowing a first user to attempt to contact a second user via a plurality of communication mechanisms.

FIG. 4 illustrates a flow diagram of an exemplary method for providing implied presence information.

FIG. 5 illustrates a flow diagram of an exemplary method for providing implied presence information in an instant messaging setting.

### DETAILED DESCRIPTION OF EXEMPLARY EMBODIMENTS

The present invention is directed to presenting a first user with an indication of the likelihood that a second user is currently within close proximity to a computer, and optionally, the likelihood that the second user is available to communicate with the first user via a communication mechanism. The likelihood that the second user is currently within close proximity to a computer or available to communicate with the first user is determined by a number of factors, including the nature of the second user's recent computer activity. The embodiments of the present invention may comprise a special purpose or general-purpose computer including various computer hardware and software components, as discussed in greater detail below.

The principles of the present invention are operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

The computing systems employed herein may also contain communication channels that allow the host to communicate with other systems and devices over, for example, a network. Although the network may include any network type (whether now existing or to be developed in the future), examples include Token Ring, Ethernet, Bluetooth, 802.11, USB, 1394, SMS, SOAP over IP, or the like. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in software and/or hardware are also possible and contemplated.

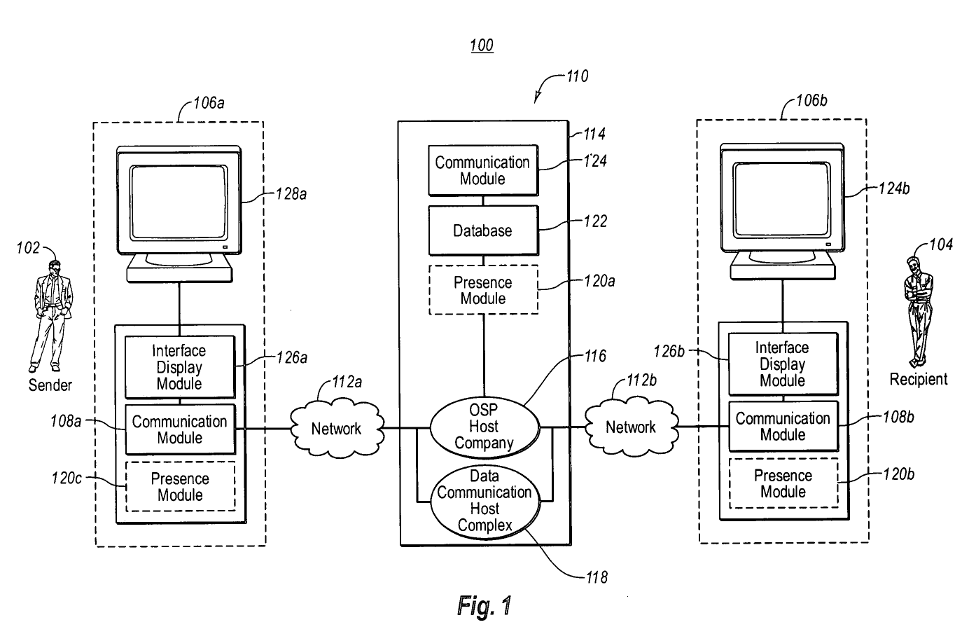

FIG. 1 shows a generalized system 100 configured to convey the likely status of a recipient 104 to a sender 102. The user of the client system 106b will be referred to herein as the “recipient.” The user of the client system 106a will be referred to as the “sender.” Recipient 104 and sender 102 will be used consistently throughout, even though both users are able to send and receive messages.

Sender 102 and recipient 104 are able to exchange data through a communications link 110, which may include a network 112a or 112b and an online service 114. The online service 114 makes a determination regarding the likely status of recipient 104. For example, the determination of the recipient's status may include whether recipient 104 is likely within close proximity to a computer or client system 106b, or whether the recipient is likely available to communicate with sender 102 through a predefined communication mechanism. This likelihood is determined based on a number of factors, including recent computer usage by recipient 104 (i.e., usage of client system 106b).

Sender 102 may desire to know the likely status of a recipient 104 for a variety of reasons. Sender 102 may desire to know the likelihood that recipient 104 is near a computer or client system 106b because the recipient's 104 close proximity to client system 106b may increase the probability that the recipient 104 could be reached via certain communication mechanisms. For example, if there is a high probability that recipient 104 is near client system 105b, the likelihood that the recipient can be reached on a telephone that is near the client system 106b also increases. Likewise, the probability that the recipient 104 can immediately be reached via email increases, where an email client is installed on client system 106b.

The probability that the recipient can be reached via other communication mechanisms also increases when there is a high likelihood that the recipient 104 is near client system 106b. This is especially true of simultaneous internet communications. As defined in the background section, simultaneous internet communication is a form of communication that takes place between two or more participants over an IP-based network that requires all participants be simultaneously connected to the IP-based network. Simultaneous internet communication provides the participants with the ability to carry on a continuous exchange of messages. Simultaneous internet communication differs from other types of online communication such as email in that email does not provide its users with the ability to continuously and simultaneously exchange messages. Instead, email requires that each sent message is independent from the last, i.e., a user must open a new window for each new email message to be sent. Furthermore, email allows a sender to send an email to any recipient, regardless of whether the recipient is currently connected to the internet.

Examples of simultaneous internet communication include instant messaging, voice over internet protocol (VoIP), certain telephone and video conferencing technologies that exchange data over an IP-based network, among other related EP-based communication protocols. Both IM and VoIP require transmission of data over an IP-based network, wherein all participants must be simultaneously connected to the IP-based network and have the ability to have a continuous and simultaneous exchange of messages. Other forms of simultaneous internet communication may exist, or may be created in the future, which fall within the scope of the present invention.

Knowing that there is a high probability that recipient 104 is in close proximity to a client system 106b can dramatically increase the odds of reaching the recipient via a simultaneous internet communication mechanism. Because simultaneous internet communication requires that both participants be online simultaneously, attempts to initiate an instant messaging conversation or a VoIP telephone call with a recipient 104 who has a low probability of being in close proximity to an online client system 106b would be rather futile.

A more detailed description will now be provided regarding the components of system 100. The determination of the likelihood status of recipient 104 is made by online service 114 in conjunction with one or more client systems 106a and 106b. Online service 114 may include an OSP (“Online Service Provider”) host complex 116, a data communication host complex 118, a database 122, and a processing module 124. A presence module 120a may also be included with online service 114. Typically, the OSP host complex 116 supports different services, such as email, discussion groups, chat, news services, and Internet access. The OSP host complex 116 is generally designed with an architecture that enables the machines within the OSP host complex 116 to communicate with each other and employs certain protocols (i.e., standards, formats, conventions, rules, and structures) to transfer data. The OSP host complex 116 ordinarily employs one or more OSP protocols and custom dialing engines to enable access by selected client applications. The OSP host complex 116 may define one or more specific protocols for each service based on a common, underlying proprietary protocol.

The data communication host complex 118 may support other forms of communication, including instant messaging. The data communication host complex 118 may support associated services, such as administrative matters, advertising, directory services, chat, and interest groups related to the form of data communication being used. The data communication host complex 118 has an architecture that enables all of the machines employing the data communication to communicate with each other. The data communication host complex 118 may employ one or more standard or exclusive protocols to transfer data.

Presence module 120a, database 122, and processing module 124 operate in conjunction with one another to determine the likely status of a particular recipient (e.g., 104). In particular, presence module 120a performs the function of monitoring a recipient's (e.g., 104) usage of a client system (e.g., 106b) in order to find indications that the recipient 104 is in close proximity with client system 106b. The data collected by presence module 120a is stored in database 122. Processing module 124 uses the information stored in database 122 to determine the likely status of recipient 104.

The presence module 120a, 120b, and/or 120c may monitor client system 106b for a variety of different types of usage. In one embodiment, presence module 120a may monitor the client system 106 for any type of use by recipient 104, including online and local (i.e., “offline”) usage. For example, presence module 120a may be configured to only monitor the online activity of recipient 104 by monitoring whether the recipient has recently sent an email, uploaded or downloaded a file from a network source, navigated the internet, sent an instant message, or participated in any other action that results in the transfer of data over an IP-based network. In another embodiment, presence module 120a only monitors offline computer usage. For example, if recipient is creating a document using word processor or spreadsheet software, or navigating through a graphical user interface using a mouse, the presence module 120a may monitor for and log these events.

The presence module may reside on the online service 114 and/or on a client computer 106a or 106b. For example, presence module 120a resides on online service 114 in an embodiment where the presence module is monitoring online activity. Alternatively, presence module 120b or 120c may also reside on client computers 106a or 106b, respectively, in an embodiment where the presence module is monitoring offline activity. Presence modules 120a, 120b or 120c may also be configured to monitor both online and offline activity. Where the presence module is located at each client, the presence module can communicate the data it collects to online service 110 via a push or pull communication protocol so that the data from all clients is maintained at a central database 122. To simplify the present discussion, reference will primarily be made to presence module 120a located at online service 114. However, it is to be understood that the presence module may also reside on each client computer within a network of computers, as illustrated by presence modules 120b and 120c.

The type usage of client system 106b monitored by presence module 120a will ultimately depend on the purpose for determining the recipient's status. As discussed previously, a sender 102 may desire to know the status of recipient 104 for a variety of purposes, including wanting to know whether the recipient 104 is in his or her office, whether the recipient is near a phone that is in close proximity to the recipient's client system 106b, whether the recipient is able to participate in a simultaneous internet communication such as an instant messaging or VoIP conversation, among various other purposes. The exact type of client system usage that is monitored by presence module 120a may vary depending on the ultimate purpose.

The data collected by presence module 120a is stored in database 122. A variety of data may be stored in database 122. For example, database 122 may store timestamp information describing the time at which monitored recipients such as recipient 104 have participated in client system activity. Additionally, database 122 may store information regarding the type of client system activity performed by recipient 104, the volume of computer usage, a list of the recipient's contacts, and various other data that may be relevant to determining if recipient would be available to communicate with a sender. By way of example, database 122 entries may include:
Date: Oct. 20, 2005; Time: 11:11 am; Activity: Word Processing activity.
Date: Oct. 20, 2005; Time: 11:24 am; Activity: Save file to network drive.
Date: Oct. 20, 2005; Time: 11:42 am; Activity: Logged off computer.
Date: Oct. 20, 2005; Time: 12:37 pm; Activity: Sent email to user A.
Etc.

The format of the data stored in database 122 may differ from what is displayed above. The type of data level of detail stored in database 122 will again depend on the ultimate purpose for determining the recipient's status.

Processing module 124 and user interface module 126a and 126b work in conjunction to display to a user (e.g., sender 102) an indication of the likely status of a recipient (e.g., recipient 104). Processing module 124 performs calculations on the data stored in database 122 to determine a likely status of recipient 104. As described previously, the particular likely status to be calculated may differ, but may include the likelihood that recipient 104 is within close proximity to client system 106b, or the likelihood that recipient 104 is available to participate in some form of communication with sender 102. The calculations performed by processing module 124 may differ according to the type of communication to be engaged in and the identity of sender 102. The data used to calculate the likely status of the recipient 104 may include the recency of the timestamps stored in database 124, the volume of activity by the recipient, the type of activity by the recipient (i.e., local use, online use, etc.), and the like.

Certain types of computer usages are more indicative of the likelihood that the recipient would be willing to participate in certain types of conversations with the sender than others. For example, if the recipient 104 has recently sent an email to a third party, then the sent email provides a decent indicator that the recipient is at the client station 106b and currently online. However, the email to the third party does not assist in the determination of whether the recipient would be willing to participate in a conversation with a particular sender (e.g., 102). If, on the other hand, the recipient 104 has recently sent an email to the sender 102, then not only is there a high probability that the recipient 104 is near the client system 106b and online, but there is an even higher probability that the recipient 104 would be willing to participate in a conversation with the sender 102.

The “presence awareness” feature of many instant messaging clients and a user's login status may also be incorporated into the calculation of determining the likely status of a user. Although these indications alone do not always provide an accurate description of the true likelihood that a user is in close proximity to a computer or available to communicate via a particular communication mechanism, they are indications that may be factored into making the ultimate determination.

User interface module 126a or 126b is a software module that is normally installed on a client system 106a or 106b, although it is possible that the user interface module 126a or 126b may reside on a central server or online service 114. User interface module 126a causes a graphical user interface (GUI) to appear on a monitor 128a displaying to sender 102 an indicator of the likely status of recipient 104.

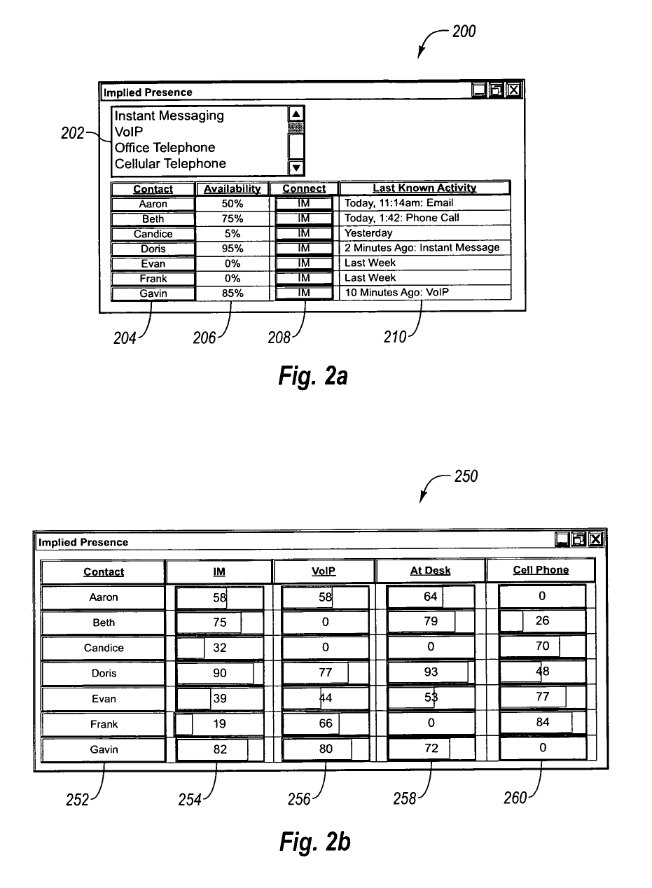

FIGS. 2a and 2b provide examples of two GUIs 202 and 252 that may be displayed to a user. The GUIs may provide a wide range of functionality and user interaction. In one embodiment, as illustrated in FIG. 2a, GUI 200 displays to the user a list of the likely statuses of certain contacts 204, as selected by the user. In one embodiment, user interface module 126a displays to the user a single default likely status. For example, in the embodiment of FIG. 2a, GUI 200 may provide the user with the likely instant messaging status for one or more recipients of column 206. Alternatively, GUI 200 may offer the user various display options, such as allowing the user to specify which likely status to be calculated and/or displayed. For example, a menu 202 may be provided to allow the user to select between the likelihood that one or more contacts 204 could be reached by office telephone, pager, cellular telephone, instant messaging, VoIP, video conferencing, and the like. When a user switches between communication mechanisms, the column 206 indicating the likelihood that each contact can be reached via the selected communication mechanisms is updated. Based on the data collected in database 122 and the calculations performed in processing module 124, the calculated likelihood may vary for each communication mechanism. For example, if a user is not likely in close proximity to a client system 106b, there is a higher likelihood that the user is reachable by cell phone or pager than by instant messaging.

As further illustrated in FIG. 2a, the GUI 200 may display a column 210 providing specific data regarding the availability of contact. For example column 210 may display the time and/or nature of the contacts' most recent computer usage.

The likely status may be displayed to a user in a number of ways. In one embodiment, as illustrated in FIG. 2a, the GUI may generate indicators 206 consisting of actual percentage values corresponding to the likelihood that a particular recipient is available via a specified communication mechanism. These probabilities may be determined by way of performing studies which correlate the usage of computers and other communication mechanisms with the probability that the user of the computer is available through certain types of communication mechanisms. For example, the study might find that individuals that have participated in computer activity within the past one minute are 90% likely to be available for an instant messaging conversation, while individuals that have not participated in any computer activity within the past 1 hour are only 10% likely to be available for an instant messaging conversation.

Alternatively, as illustrated in FIG. 2b, a GUI 250 may display the indicators as a graphical depiction of the likelihood that a contact 252 might be reached via various communication mechanisms. The graphical depictions of FIG. 2b include sliding scales representing the likelihood that each contact 252 might be available to communicate via instant messaging (IM) 254, Voice over Internet Protocol (VoIP) 256, cell phone 260, and also the probability that the contact 252 is within close proximity to the contact's computer 258 (i.e., close to the user's desk).

Other displays may be used in addition to those depicted in exemplary FIGS. 2a and 2b. For example, the graphical user interface (GUI) may be configured to display a numerical scale to the user, ranging from one to ten, where ten is the highest likelihood that the recipient is available via a specified communication mechanism. Alternatively, a color-coded scale may be displayed to the sender, wherein different colors are designated as distinct probability levels for the likelihood that a particular recipient is available via a specified communication mechanism.

The GUIs 200 and 250 can also include a selectable link to a first communication mechanism. For example, as illustrated in FIG. 2a, the GUI 200 may include one or more links 205, that when selected, opens a conventional instant messaging interface for allowing the sender 102 to type a message and send the message to the recipient 104. If the recipient is available and responds, the recipient's response appears in the instant messaging interface, and the sender 102 and recipient 104 are free to participate in an ongoing IM conversation. Similarly, each of the sliding scale indicators 254, 256, and 260 may include a selectable link for initiating a conversation with the intended recipient 104 via the selected communication mechanism. Notably, the instant messaging client (or other communication mechanism) need not be provided by the present invention. Instead, the invention may be configured such that selecting one of the communication links 208, 254, 256, or 260 merely initiates communication via the selected mechanism. Alternatively, the present invention may include an integrated communication mechanism, such as an instant messaging client. Providing integrated communication mechanisms may minimize errors that may occur in interfacing between multiple communication modules of differing protocols.

The interface module 126a or 126b of the present invention may provide much more functionality than is displayed in exemplary FIGS. 2a and 2b. For example, the interface module 126a or 126b may be configured to allow a sender 102 to customize the display and calculation of the likely status. For instance, sender 102 may customize user interface module 126a to display the likelihood that recipient 104 would be responsive to a communication that is specifically originated by sender 102. As described above, certain online activities may increase the probability that a recipient would be responsive to a communication from a specific sender, such as if the recipient had recently sent an email to the particular sender. Other factors may personalize the status report, such as whether recipient 104 includes sender 102 in a list of contacts, or an address book.

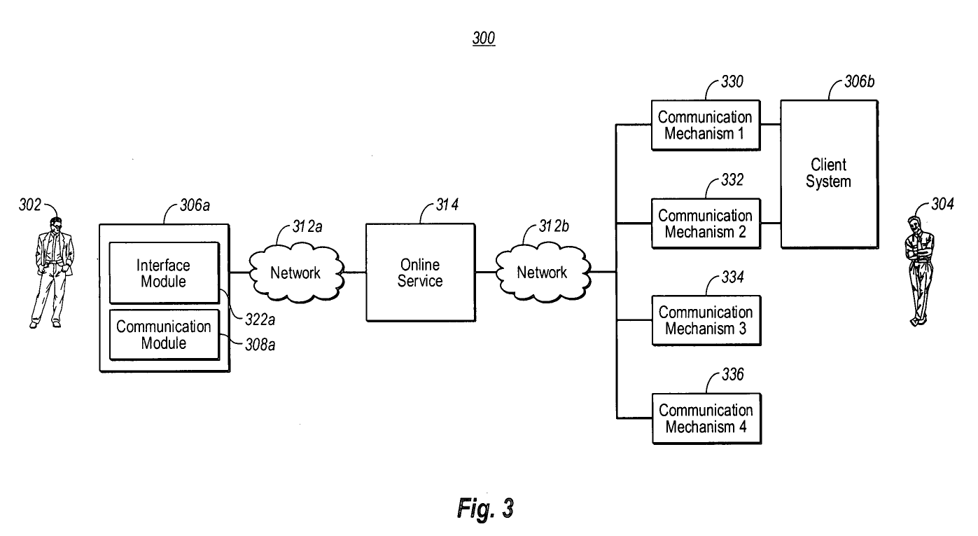

If recipient 104 is non-responsive to the message sent via the first communication mechanism, user interface module 126a may provide the sender 102 with the option of forwarding the message to the recipient 104 using an alternative communication mechanism. This embodiment is illustrated in FIG. 3. FIG. 3 shows a sender 302 using client system 306a, attempting to communicate with recipient 304 (user of client system 306b). Sender 304 initially learns via user interface module 322a that recipient 304 is likely within close proximity to client system 306b. Therefore, user interface module 322a and communication module 308a attempt to contact recipient via a first communication mechanism 330. If recipient 304 is not responsive to the communication sent via the first communication mechanism 330, an attempt may be made to contact recipient 304 via an alternative communication mechanism 332, 334, or 336.

In the embodiment of FIG. 3, the first communication mechanism 330 and the second communication mechanism 332 attempt to communicate with recipient 304 via client system 306b. Once it is determined that recipient 304 is likely within close proximity to client system 306b, it is most logical to begin by first attempting to communicate by way of the client system 306b. In particular, first and second communication mechanisms 330 and 332 may include instant messaging, VoIP, or other simultaneous internet communication mechanisms as defined herein. If recipient 304 is unresponsive to attempts to communicate via a simultaneous internet communication, attempts may be made to communicate with recipient 304 via other communication mechanisms 334 and 336, which may include telephone, mobile devices, pagers, email, or any other communication mechanism.

Therefore, if recipient 104 was unresponsive to an instant message sent from the sender 102, the user interface module 122 may automatically notify the sender 102 that the first communication mechanism failed. Presence module 120a may also incorporate the data regarding the failed attempt into the calculation of likely status. The user interface module 122 may then automatically attempt to communicate with the recipient 104 via an alternative communications mechanism. Alternatively, the user interface module 122 may merely suggest an alternative communications mechanism to the sender 102. The user interface module 122 may base the selection of an alternative communications mechanism on which communications mechanism offers the highest probability of contacting the recipient 104. Communication module 108a or 108b may be configured to handle the transmission of messages via multiple communication mechanism protocols to enable a user to easily select between all available communication mechanisms. Further detail regarding the cascading of multiple delivery mechanisms can be found in co-pending U.S. patent application Ser. No. 10/320,712, and co-pending U.S. patent application Ser. No. 11/005,348, both of which applications are hereby incorporated by reference in their entireties.

The monitoring activities of presence module 120a and the ability to distribute and display data regarding computer usage may create privacy concerns in certain situations. These privacy concerns are addressed in a number of ways. First, in most embodiments, very little detail regarding the type of computer usage participated in by the recipient 104 is displayed to the sender 102. The sender 102 typically only receive an indication of the likely status of the recipient 104 based on the data collected by the presence module 120a and stored in database 122.

Furthermore, limitations may be placed on who is allowed to see a user's status information. These limitations may be configured using user interface module 126a or 126b. In one embodiment, users are allowed to select among people with whom the user is willing to distributing likely status information. For example, users may be provided with the option of sharing likely status information with all contacts in a contact list, or perhaps certain groups of contacts.

In addition, there are other situations where privacy is less of a concern. For example, the principles of the present invention may be applied to a local area network (LAN), where all users are friends or colleagues. In the workplace, the ability to quickly contact coworkers is of increasing importance, and monitoring of certain computer usage is more expected. Therefore, privacy of computer usage becomes less of an issue.

The present invention may also be described in terms of methods comprising functional steps and/or non-functional acts. The following is a description of steps and/or acts that may be preformed in practicing the present invention. Usually, functional steps describe the invention in terms of results that are accomplished whereas non-functional acts describe more specific actions for achieving a particular result. Although the functional steps and/or non-functional acts may be described or claimed in a particular order, the present invention is not necessarily limited to any particular ordering or combination of steps and/or acts.

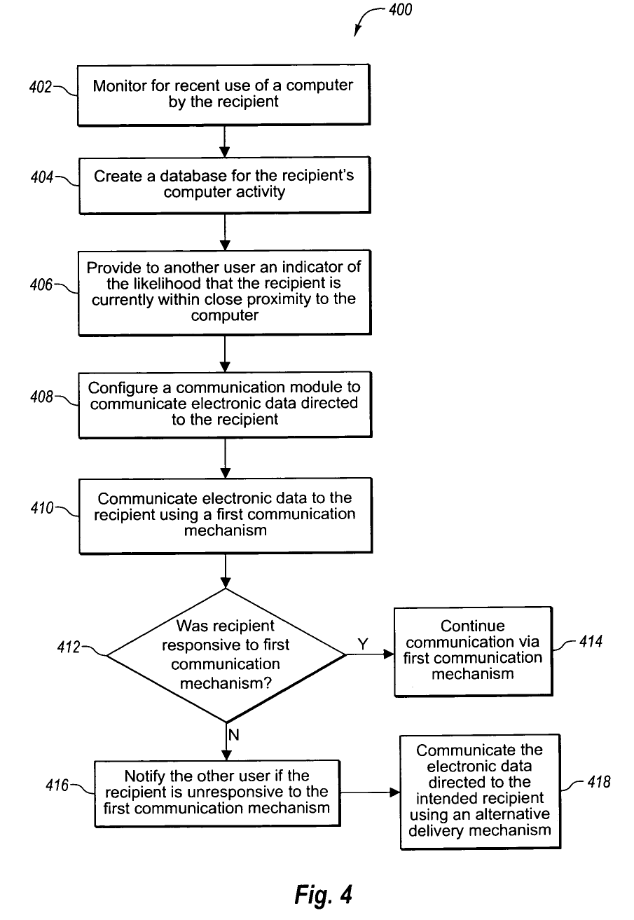

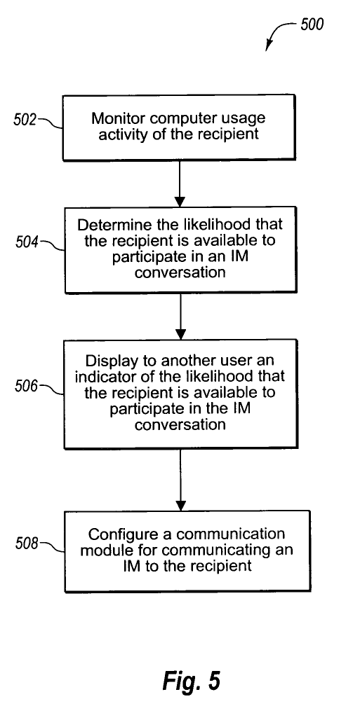

FIGS. 4 and 5 illustrate flow diagrams for various exemplary embodiments of the present invention. The following description of FIGS. 4 and 5 may occasionally refer to corresponding elements from FIGS. 1 and 3. Although reference may be made to a specific element from these figures, such elements are used for illustrative purposes only and are not meant to limit or otherwise narrow the scope of the present invention unless explicitly claimed. Note that portions of the description of method 400 of FIG. 4 may apply to method 500 of FIG. 5, and portions of the description of method 500 of FIG. 5 may likewise apply to method 400 of FIG. 4.

FIG. 4 illustrates a flow diagram for a method 400 of determining the likelihood that an intended recipient is available to participate in online communication. Method 400 includes, at 402, monitoring for indications that the intended recipient has participated in recent use of a computer. As described above, this step may be performed by presence module 120a, which may monitor a wide variety of computer usage depending on the situation, including the sending emails, performing web searches, uploading or downloading a file from a network source, navigating a network, using a program installed on the computer, and the like.

Method 400 also includes, at 404, creating a database including a timestamp for the most recent computer activity of the intended recipient. The database may include a variety of additional information, including the volume of computer activity, the type of computer usage, information regarding the intended recipient's contact lists, among other data relevant to determining the likely status of at least one other user.

Further, method 400 also includes, at 406, providing to at least one other user an indicator of the likelihood that the intended recipient is currently within close proximity to the computer based on at least the recency of the timestamp for the most recent online activity. The indicator may be displayed to the user on a monitor 128a via the user interface module 126a. The calculation of the likelihood that the intended recipient is currently within close proximity to the computer may be calculated by processing module 124.

Method 400 also includes, at 408, configuring a communication module to communicate electronic data directed to the intended recipient. The communication module may reside on a client system, and may be configured to communicate to a variety of communication mechanisms, as illustrated in FIG. 3.

At 410, method 400 may include communicating electronic data to the intended recipient using a first communication mechanism. A user may select which communication mechanism to use, or a default first communication mechanism may be configured. Typically, a simultaneous internet communication mechanism, as defined herein, is employed as the first communication mechanism because it allows the intended recipient and one or more users to exchange communications in a real-time manner. If the indicator at 406 shows that there is a high likelihood that the intended recipient is close to a computer, then the likelihood that the intended recipient is able to communicate via a simultaneous internet communication mechanism such as instant messaging or VoIP is also increased.

After the user elects to send the recipient electronic data via the first communication mechanism, method 400 may determine, at 412, whether the intended recipient was responsive to the electronic data sent via the first communication mechanism. If the intended recipient was responsive, then the communication between the intended recipient and the at least one other user continues, as shown at 414. However, if the intended recipient was unresponsive, then the at least one other user is notified, at 416, that the attempt to communicate via the first communication was unsuccessful. Then, method 400 may include, at 418, attempting to communicate the electronic data to the intended recipient using an alternative delivery mechanism. The alternative delivery mechanism may be another simultaneous internet communication mechanism, or any other communication mechanism such as telephone, email, text messaging, and the like.

FIG. 5 illustrates a flow diagram for a method 500 of providing an indication of the likelihood that an intended recipient is available to participate in an instant messaging conversation. Method 500 includes, at 502, monitoring computer usage activity of the intended recipient in addition to the presence awareness indicator provided by an instant messaging client. Although the presence awareness indicator may be taken into consideration, other types of computer usage are also monitored, as described above. Method 500 further includes, at 504, determining a likelihood that the intended recipient is available to participate in the instant messaging conversation based on the recency of the intended recipient's computer usage activity. As described above, if the recipient has recently used his or her computer, the likelihood that the recipient is available to participate in an instant messaging conversation increases.

Method 500 also includes, at 506, displaying to at least one other user an indicator of the likelihood that the intended recipient is available to participate in the instant messaging conversation. As described above, this indicator may take a variety of forms, including color-coded or numerical computer interface icons. Further, method 500 may include, at 508, configuring a communication module for communicating an instant message from the at least one user to the intended recipient.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The invention further extends to computer systems adapted for use with user interfaces that operate as described herein. Those skilled in the art will understand that the invention may be practiced in computing environments with many types of computer system configurations, including personal computers, multi-processor systems, network PCs, minicomputers, mainframe computers, and the like. The invention will be described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

The present invention may be embodied in other specific forms without departing from its spirit or essential characteristics. The described embodiments are to be considered in all respects only as illustrative and not restrictive. The following exemplary claim is presented to illustrate various novel features of the present invention. The claim is not exhaustive of the embodiments of the invention, nor is it to be construed as limiting the scope of the invention. Moreover, the invention disclosed in detail herein can be defined with other claims, including those that will be included in any related non-provisional applications that will be filed during the pendency of this provisional application.

What is claimed is:

1. A method for determining a likelihood that an intended recipient is within close proximity to a computer, the method comprising:
monitoring for indications that the intended recipient has participated in recent use of the computer;
creating a database including at least one timestamp for the recent use of the computer; and
providing to a first user an indicator of the likelihood that the intended recipient is within close proximity to the computer, the likelihood based on at least the recency of the at least one timestamp for the recent use of the computer.

2. The method as recited in claim 1, comprising configuring a communication module to communicate electronic data directed to the intended recipient.

3. The method as recited in claim 1, wherein monitoring for indications that the intended recipient has participated in recent use of the computer comprises monitoring at least one of online or offline activity.

4. The method as recited in claim 1, wherein the first user is only provided with the indicator if the first user has been authorized to receive the indicator by the intended recipient.

5. The method as recited in claim 1, wherein the likelihood that the intended recipient is within close proximity to the computer decreases as the amount of time increases since the most recent computer activity.

6. The method as recited in claim 1, further comprising providing to the first user an indicator of the likelihood that the intended recipient is currently available to communicate via one or more communication mechanisms.

7. The method as recited in claim 6, wherein the one or more communication mechanisms is an internet protocol-based communication mechanism.

8. The method as recited in claim 7, wherein the internet protocol-based communication mechanism is a simultaneous internet protocol-based communication mechanism, requiring that the first user and the intended recipient both be connected to the internet simultaneously in order to exchange communications, the simultaneous internet protocol-based communication mechanism being comprised of at least one of an instant messaging client, a voice over internet protocol (VoIP) service, an internet protocol-based teleconferencing service, or an internet protocol-based videoconferencing service.

9. The method as recited in claim 6, further comprising at least one of:
communicating electronic data to the intended recipient using the communication mechanism at the prompt of the first user;
notifying the first user if the intended recipient is unresponsive to the communicated electronic data; or communicating the electronic data directed to the intended recipient using an alternative communication mechanism.

10. The method as recited in claim 9, wherein the alternative communication mechanism is at least one of an instant messaging service, a mobile client, an electronic mail service, a paging service, telephone networks, or text messaging.

11. The method as recited in claim 1, wherein the indicator is at least one of a numerical scale or a color-coded scale.

12. A method for providing an indication of a likelihood that an intended recipient is available to participate in an instant messaging conversation, the method comprising:
monitoring computer usage activity of the intended recipient;
determining the likelihood that the intended recipient is available to participate in the instant messaging conversation, the likelihood being based on at least the recency of the intended recipient's online activity; and
displaying to a first user an indicator of the likelihood that the intended recipient is available to participate in the instant messaging conversation.

13. The method as recited in claim 12, further comprising providing the first other user with a mechanism for initiating the instant messaging conversation.

14. The method as recited in claim 13, wherein the mechanism for initiating the instant messaging conversation includes a link to an instant messaging client.

15. The method as recited in claim 12, wherein monitoring for indications that the intended recipient has participated in recent use of the computer comprises monitoring at least one of online or offline activity.

16. The method as recited in claim 12, wherein the first user is only provided with the indicator if the user has been authorized to receive the indicator by the intended recipient.

17. The method as recited in claim 12, wherein the likelihood that the intended recipient is within close proximity to the computer decreases as the amount of time increases since the most recent computer activity.

18. The method as recited in claim 12, wherein the indicator is at least one of numerical scale or a color-coded scale.

19. A system that determines a likelihood that an intended recipient is currently available to communicate via at least one communication mechanism, the system comprising:
a presence module for monitoring the computer usage activity of the intended recipient;
a database for storing timestamps of the intended recipient's computer usage activity;
a processing module for determining the likelihood that the intended recipient is currently available to communicate via the at least one communication mechanism, the likelihood being determined based on at least the recency of the most recent timestamp; and
a user interface module for displaying to a first user an indicator of the likelihood that the intended recipient is currently available to communicate via the at least one communication mechanism.

20. The system as recited in claim 19, further comprising a communication module for enabling the first user to initiate a communication with the intended recipient via the at least one communication mechanism.
